(19) United States
(12) Patent Application Publication
(10) Pub. No.: US 2011/0220702 A1
(43) Pub. Date: Sep. 15, 2011

(54) POSTERIOR LOCKING DEVICE FOR NAIL CARTRIDGE OF NAIL GUN

(75) Inventors: Chin-Chi CHEN, Taichung (TW); Chun-Chi Lai, Taichung (TW)

(73) Assignee: BASSO INDUSTRY CORP., Taichung (TW)

(21) Appl. No.: 13/044,816

(22) Filed: Mar. 10, 2011

(30) Foreign Application Priority Data
Mar. 11, 2010 (TW) 99101765

(51) Int. Cl. B25C 5/16

(52) U.S. Cl. 227/126

(57) ABSTRACT

A posterior locking device for use in a nail cartridge of a nail gun can hold a movable nail pusher at a rear part of the nail cartridge. The posterior locking device includes a locking member movably mounted to the rear part of the nail cartridge, a springy member for providing resilience forcing the locking member back to an initial position, and a guide post fixed to the nail pusher. When the nail pusher is externally forced to slide to the rearmost end of the nail cartridge and then released from the external force, the guide post can be locked into the locking member to hold the nail pusher at the rear part of the nail cartridge temporarily. Next, when the nail pusher is externally forced to the rearmost end again, the guide post can disengage from the locking member to allow the nail pusher to move back and forward.

### BACKGROUND OF THE INVENTION

1. Field of the Invention

The present invention relates generally to a nail cartridge of a nail gun, and more particularly, to a posterior locking device for the nail cartridge of the nail gun.

2. Description of the Related Art

Generally speaking, a plurality of nails arranged parallel in a row are put into a nail cartridge of a nail gun and a nail pusher is provided in the nail cartridge. The nail pusher can be driven by a spring to movably push the nails toward a to-be-hit position at the front end of the nail cartridge. In this way, after one nail is hit, the other nails will move forward to replace it to allow the nails to enter the to-be-hit positions one by one. When it is intended to resupply the nails, a user needs to make the nail pusher move to the rear end of the nail cartridge before the resupply operation. To allow the user not to necessarily keep his or her hand applying a force to the nail pusher while resupplying the nails, the nail cartridge internally needs a locking device to temporarily fasten the nail pusher to the rear end of the nail cartridge. After the nail resupply is finished, the nail pusher can be released to disengage from the rear end of the nail cartridge.

For example, U.S. Pat. No. 7,549,562 discloses a positioning device for a nail pusher of a nail cartridge, where the nail pusher has a curved guide groove, which is engaged with a swing link pivoted to the rear end of the nail cartridge to allow the guide groove to be engaged with the swing link, when the nail pusher slides from the front end of nail pusher to the rearmost end to be released, to further position the nail pusher to the rear end of the nail cartridge; when the nail pusher is moved to the rearmost end once again to be released, the swing link can disengage from the guide groove to allow the nail pusher to slide toward the front end of the nail cartridge till it is stopped against the nail. Although such device can hold the nail pusher for the time being and then release it, the rotational stroke of the swing link is greater, so it is subject to non-smooth operation and shortened service life of the spring of the swing link to need further improvement.

### SUMMARY OF THE INVENTION

The primary objective of the present invention is to provide a posterior locking device for use in a nail cartridge of a nail gun, which can resupply the nails in the nail cartridge and then quickly release the nail pusher.

The foregoing objective of the present invention is attained by the posterior locking device composed of a locking member, at least one springy member, and a guide post. The locking device is movably mounted to a rear part of the a shell of the nail cartridge and includes a curved guide groove having an entrance end whose opening faces forward, a cavity formed on an internal wall of a midsection of the curved guide groove and having an opening facing backward, and an exit end. The locking member further includes a slope extending toward the entrance end. The at least one springy member is mounted to the rear part of the shell and connected with the locking member for providing resilience which can force the locking member back to an initial position. The guide post is fixed to the nail pusher and can be moved back and forth along with the forward and backward sliding of the nail pusher. In this way, when the nail pusher is externally forced to slide to the rearmost end of the shell and then released from the external force, the guide post enters the curved guide groove to be locked into the cavity to hold the nail pusher in the rear part of the shell temporarily. Next, as long as the nail pusher is pushed backward by an external force to the rearmost end of the shell again, the guide post can disengage from the cavity and then the external force applied is released to allow the guide post to disengage from the locking member in such a way that the nail pusher can move back and forth.

### BRIEF DESCRIPTION OF THE DRAWINGS

FIG. 1 is a perspective view of a first preferred embodiment of the present invention mounted to a nail cartridge of a nail gun.

FIG. 2 is a view of a front part of the first preferred embodiment of the present invention, illustrating that the locking member is located at the initial position.

FIGS. 3-8 are similar to FIG. 2, illustrating the operational process of the present invention.

FIG. 9 is a view of a second preferred embodiment of the present invention, illustrating that the posterior locking device is mounted to the nail cartridge of the nail gun.

### DETAILED DESCRIPTION OF PREFERRED EMBODIMENTS

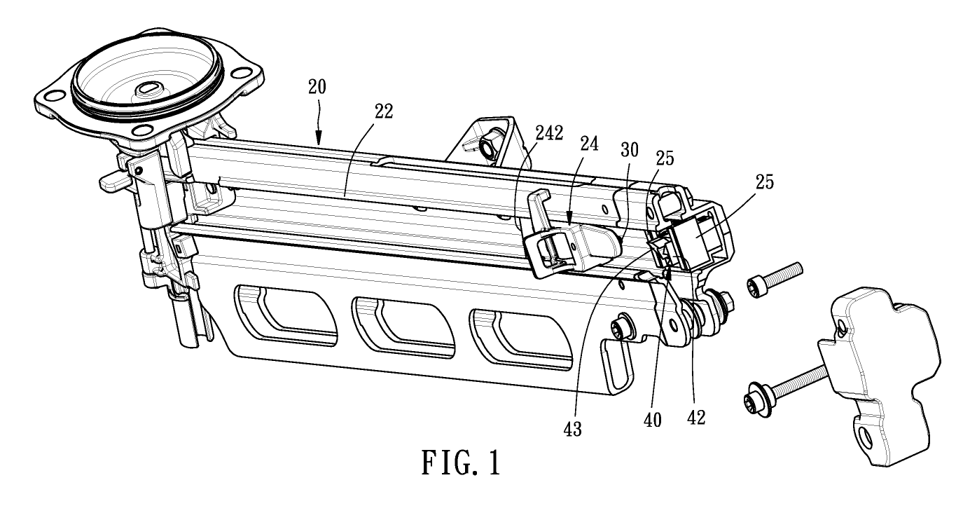

Referring to FIGS. 1-8, a posterior locking device 10 constructed according to a first preferred embodiment of the present invention is mounted to a nail cartridge 20 of a nail gun (not shown). The nail cartridge 20 is comprising a shell 22 and a nail pusher 24. The nail pusher 24 is mounted to the shell 22 and can linearly slide back and forth therein. The posterior locking device 10 is comprising a guide post 30 fixed to the nail pusher 24, a locking member 40 mounted to a rear part of the shell 22, two first springy members 52, and two second springy members 54. The detailed descriptions and operations of these elements as well as their interrelations are recited in the respective paragraphs as follows.

A spring (not shown) is mounted between the nail pusher 24 and the shell 22 for providing resilience which can force the nail pusher 24 to face a front end of the shell 22 in such a way that the nail pusher 24 can slide toward a rear end of the shell 22, while externally forced by a resistance against the resilience, and then be driven to slide toward the front end of the shell 22, while released from the external resistance. The guide post 30 extends vertically from a tail of the nail pusher 24 toward an inside of the shell 22, so the guide post 30 can reciprocate forward and backward while the nail pusher slides forward and backward.

The locking member 40 is cubic and includes a first convexity 42 and a second convexity 43, which integrally extend from one surface 41 thereof, a slope 44 perpendicular to the surface 41, and a curved guide groove 45. In other words, the curved guide groove 45 has an entrance end 451 and an exit end 452. The entrance end 451 is provided with an opening facing forward. Facing the second convexity 43, one side of the first convexity 42 defines an internal wall of the curved guide groove 45. The curved guide groove 45 further has a first bevel 453, a recess 454, and a second bevel 455 in order from the entrance end 451 toward the exit end 452. The second convexity 43 has two adjacent sides, one of which faces the first convexity 42 to define a cavity 456 having an opening facing backward of the curved guide groove 45. The cavity 456 is located on a middle part of the internal wall of the curved guide groove 45 and its opening faces the midst of the recess 454 and the second bevel 455. The other side of the second convexity 43 defines the slope 44 extending backward toward the entrance end 451.

The locking member 40 and the first and second springy members 52 and 54 are mounted to a slide groove 26 defined by two retaining members 25 located at the rear end of the shell 22. The first and second springy members 52 and 54 are coil springs. The first springy members 52 are mounted to a first side 47 of the locking member 40. The second springy members 54 are mounted to a second side 48 opposite to the first side 47. The first and second springy members 52 and 54 are connected between the locking member 40 and the internal wall of the shell 22. In this way, when the locking member 40 is not externally forced, the locking member 40 is confined by the first and second springy members 52 and 54 of the first and second sides 47 and 48 to be located at an initial position P1 that is a center of the slide groove 26. While externally forced, the locking member 40 can only linearly reciprocate along a direction perpendicular to the sliding direction of the nail pusher 24 toward the first and second sides 47 and 48. After released from the external force, the first and springy members 52 and 54 can resiliently force the locking member 40 back to the initial position P1.

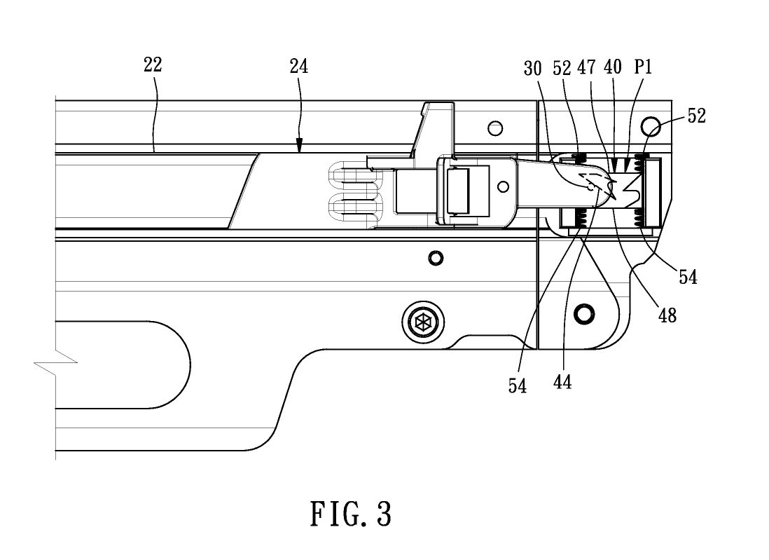

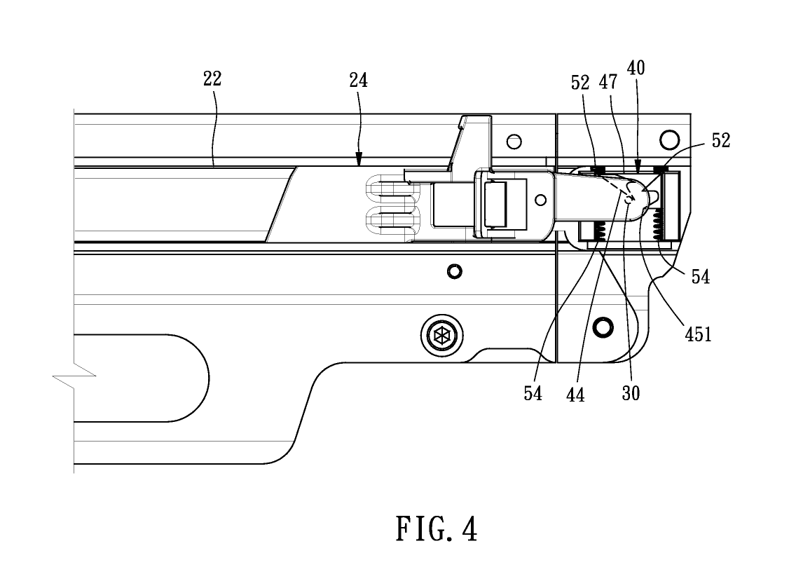

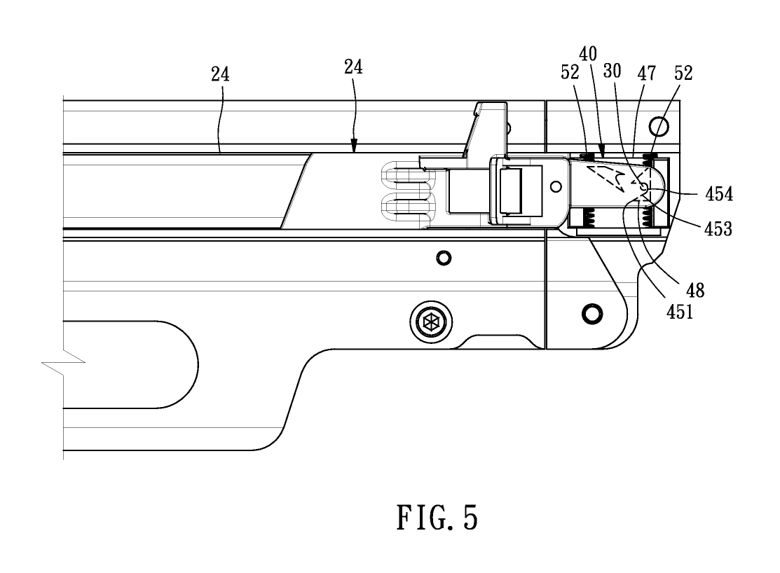

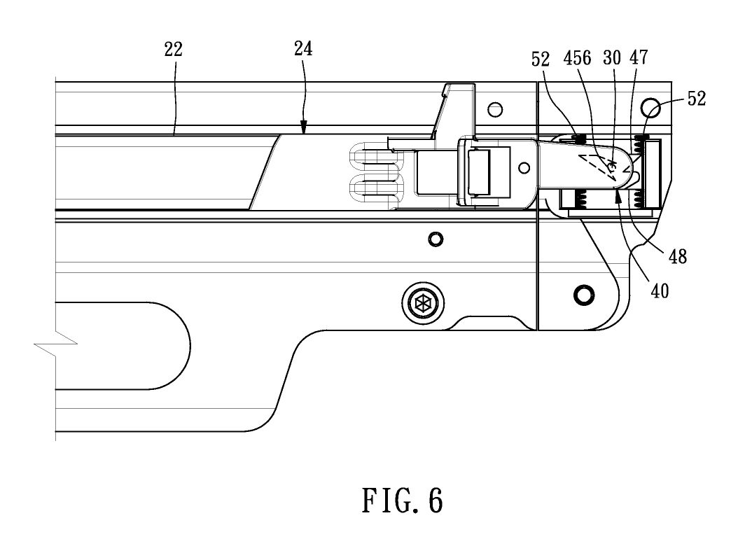

In general, the guide post 30 is separated from the locking member 40 and a front end 242 of the nail pusher 24 is pushed against nails (not shown) located in the shell 22 and in front of the nail pusher 24. When the nails inside the shell 22 are depleted to need resupply, a user needs to keep forcing the nail pusher 24 to slide toward the rear end of the shell 22. When the nail pusher 24 slides to approach the locking member 40, the guide post 30 can be pushed against the slope 44, as shown in FIG. 3. In the meantime, when the user keeps forcing the nail pusher 24 to continue to slide backward, a component of force is generated on the slope 44 from the guide post 30 to push the locking member 40 to slide toward the first side 47; meanwhile, the guide post 30 can relatively slide along the slope 44 toward the entrance end 451, as shown in FIG. 4. Next, the user can keep forcing the nail pusher 24 to slide further backward, and then the guide post 30 can enter the guide groove 45 through the entrance end 451 and relatively slide along the first bevel 453 of the locking member driven by the first springy member 52 to slide toward the second side 48 till the guide post 30 enters the recess 454; meanwhile, the nail pusher 24 reaches the rearmost end of its sliding stroke and fails to slide backward any longer, as shown in FIG. 5. In this way, the user can stop applying any force to the nail pusher 24 and immediately the released nail pusher 24 can slide toward the front end of the shell 22. In the meantime, the locking member 40 can be driven by the first springy member 52 to slide toward the second side 48. After the locking member 40 slides for a short distance, the guide post 30 is locked into the cavity 456 to keep the nail pusher 24 at the rear part of the shell 22 from sliding forward any longer, as shown in FIG. 6. At the moment, the user can resupply the nails in the front of the nail pusher 24.

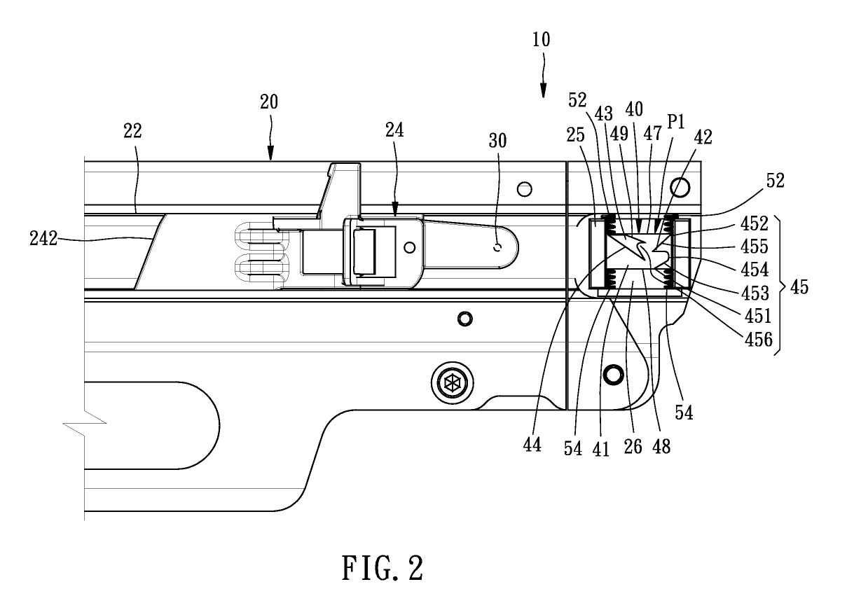

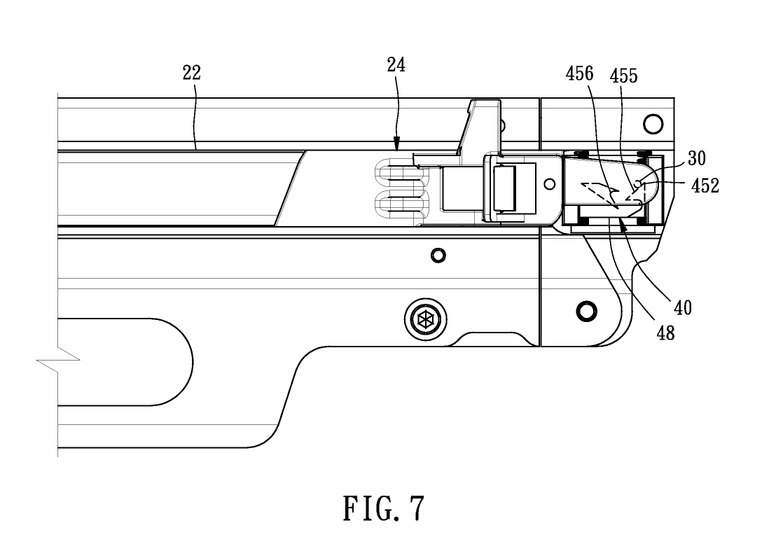

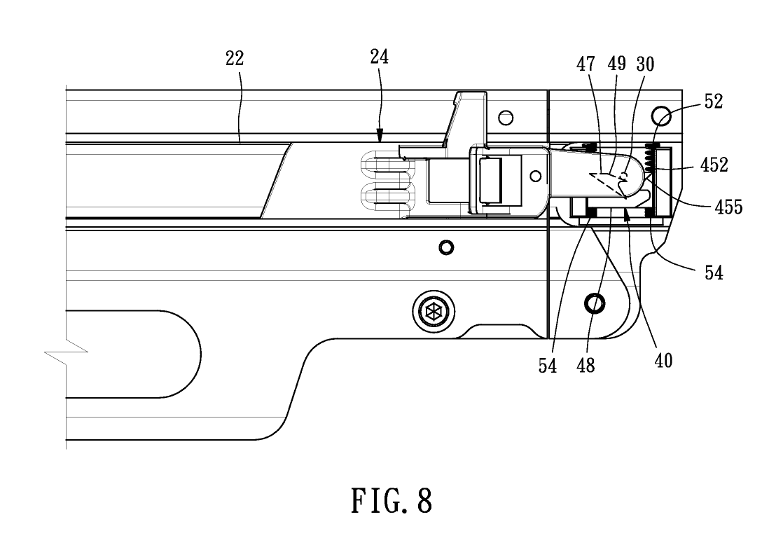

When the user finishes the nail resupply and intends to force the nail pusher 24 to push against the nails as shown initially, the user only needs to push the nail pusher 24 to slide to the rearmost end of the shell 22 and thus the guide post 30 can disengage from the cavity 456 and then generate a component of force perpendicular to the second bevel 455 on the second bevel 455 for pushing the locking member 40 to slide toward the second side 48; meanwhile, the guide post 30 can relatively slide along the second bevel 455 toward the exit end 452, as shown in FIG. 7. At this time, the user can stop applying any force to the nail pusher 24 and then the released nail pusher 24 can force the guide post to disengage from the guide groove 45 through the exit end 452 and to slide toward the front end of the shell 22; meanwhile, the locking member 40 can be driven by the second springy member 54 to slide toward the first side 47, so the guide post 30 can relatively slide along an inclination 49 of the second convexity 43 and then disengage from the locking member 40, as shown in FIG. 8. Next, the locking member 40 can be driven by the second springy member 54 to slide toward the first side 47 to return to the initial position P1 shown in FIG. 2.

By means of the locking device 10, when the user intends to resupply the nails to shell 22, the user can position the nail pusher 24 at the rear part of the shell 22 for the time being and then quickly release the nail pusher 24 after the resupply is finished. It is to be noted that the numbers of the first springy member 52 and the second springy member 54 stopped against the first and second sides 47 and 48 separately are not limited to two each but can be one as long as the resilience of the first and second springy members 52 and 54 can force the locking member 40 back to the initial position P1. In addition, only the first or second springy member 52 or 54 can alternatively be mounted to the first or second side 47 or 48 to enable the locking member 40 to linearly slide in the slide groove 26 due to the stretchability and compressibility of the springy members. Further, the locking member 40 and the springy members 52 and 54 can alternatively function in another embodiment as recited below.

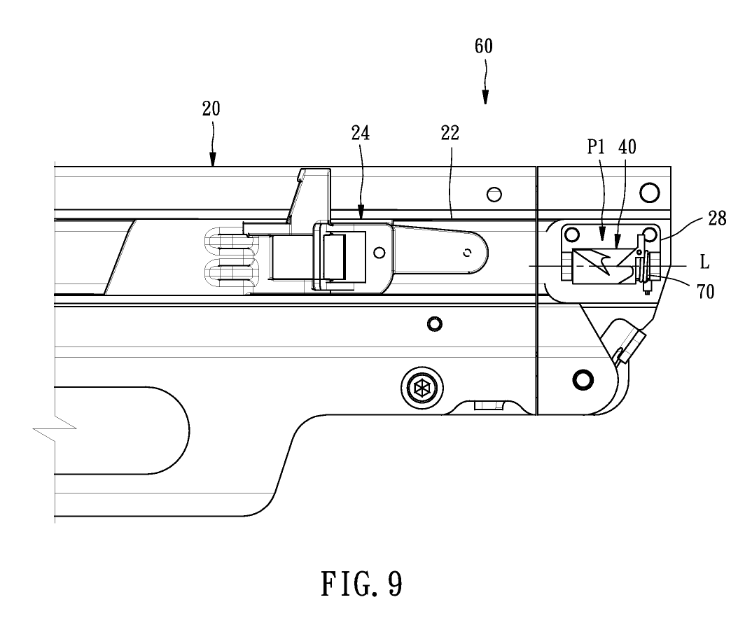

Referring to FIG. 9, a locking device 60 constructed according to a second preferred embodiment of the present invention is similar to that of the first embodiment, having the following difference. The locking member 40 is pivotably mounted to the rear part of the shell 22 of the nail cartridge 20 and connected with a springy member 70 which is a torsion spring. In other words, the locking member 40 is pivotably mounted to a fastening member 28 located at the rear end of the shell 22, and the springy member 70 is connected between the locking member and the fastening member 28. In light of this, when the locking member 40 is not externally forced, the locking member 40 can only pivot on a central axis L parallel to the sliding direction of the nail pusher 24. After the locking member 40 is released from the external force, the springy member 70 can provide the resilience forcing the locking member 40 back to the initial position P1. In this way, according to the operation of the locking device 60, the pivoting movement of the locking member 40 can reach the same effect as that of the locking device 10 in the first embodiment.

What is claimed is:

1. A posterior locking device for use in a nail cartridge of a nail gun, the nail cartridge having a shell and a nail pusher mounted in the shell for linearly forward and backward reciprocating movement, the posterior locking device adapted for holding the nail pusher at a rear part of the shell, the posterior locking device comprising:
a locking member movably mounted to the rear part of the shell and having a curved guide groove and a slope, the curved guide groove having an entrance end whose opening facing forward, a cavity being formed on an internal wall of a midsection of the curved guide groove and having an opening facing backward, and an exit end, the slope extending toward the entrance end;
at least one springy member mounted to the rear part of the shell and connected with the locking member for providing resilience forcing the locking member back to an initial position; and
a guide post fixed to the nail pusher for forward and backward movement together with the forward and backward sliding of the nail pusher.

2. The posterior locking device as defined in claim 1, wherein the curved guide groove comprises a first bevel, a recess, and a second bevel in order from the entrance end toward the exit end; the cavity having an opening facing the recess and the second bevel; when the guide post enters the curved guide groove through the entrance end as the nail pusher is moved, the guide post can relatively slide to the recess along the first bevel.

3. The posterior locking device as defined in claim 1, wherein the locking member comprises a first convexity and a second convexity; the first and second bevels and the recess are located at one side of the first convexity facing the second convexity, the second convexity having two adjacent sides, one of which faces the first convexity and defines the cavity and the other of which defines the slope.

4. The posterior locking device as defined in claim 1, wherein the locking member is mounted to the rear part of the shell and can linearly slide back and forth along a direction perpendicular to the sliding direction of the nail pusher.

5. The posterior locking device as defined in claim 4, wherein the at least one springy member comprises a first springy member and a second springy member, which are connected between the locking member and the shell and stopped against a first side and a second side of the locking member separately, the first side being opposite to the second side, the locking member being slidable back and forth toward the first and second sides.

6. The posterior locking device as defined in claim 5, wherein the at least one springy member further comprises another first springy member and another second springy member.

7. The posterior locking device as defined in claim 1, wherein the locking member can pivot on a central axis parallel to the sliding direction of the nail pusher.

8. The posterior locking device as defined in claim 7, wherein one of the first and second springy members is a torsion spring connected between the locking member and a fastening member fixed to the shell.
